(19) United States
(12) Patent Application Publication
(10) Pub. No.: US 2026/0181529 A1
(43) Pub. Date: Jun. 25, 2026

(54) VALIDATING SIB1 REQUEST CONFIGURATION

(71) Applicant: Samsung Electronics Co., Ltd., Suwon-si (KR)

(72) Inventors: Anil Agiwal, McKinney, TX (US); Kyeongin Jeong, Frisco, TX (US); Hongbo Si, Allen, TX (US)

(21) Appl. No.: 19/420,719

(22) Filed: Dec. 15, 2025

Related U.S. Application Data
(60) Provisional application No. 63/738,269, filed on Dec. 23, 2024.
(60) Provisional application No. 63/776,660, filed on Mar. 24, 2025.
(60) Provisional application No. 63/801,292, filed on May 7, 2025.

(51) Int. Cl. H04W 48/14

(52) U.S. Cl. CPC H04W 48/14

(57) ABSTRACT

A user equipment (UE) includes a transceiver configured to, while the UE is in an RRC_CONNECTED state, receive, from a primary cell (PCell), a system information block (SIB) including a SIB1 request configuration of one or more cells. The UE also includes a processor operably coupled to the transceiver. The processor is configured to, upon a radio link failure, start a timer T311, and while the timer T311 is running, select a cell. The transceiver is further configured to transmit a SIB1 request to the selected cell in response to a determination by the processor that (i) the selected cell provides SIB1 on demand and (ii) the SIB including the SIB1 request configuration of the one or more cells includes a SIB1 request configuration of the selected cell.

### CROSS-REFERENCE TO RELATED APPLICATION(S) AND CLAIM OF PRIORITY

This application claims priority under 35 U.S.C. § 119 (e) to U.S. Provisional Patent Application No. 63/738,269 filed on Dec. 23, 2024, U.S. Provisional Patent Application No. 63/776,660 filed on Mar. 24, 2025, and U.S. Provisional Patent Application No. 63/801,292 filed on May 7, 2025. The above-identified provisional patent applications are hereby incorporated by reference in their entirety.

### TECHNICAL FIELD

This disclosure relates generally to wireless networks. More specifically, this disclosure relates to validating system information block 1 (SIB1) request configurations.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveforms (e.g., new radio access technologies [RATs]) to flexibly accommodate various services/applications with different requirements, new multiple access schemes to support massive connections, etc.

### SUMMARY

This disclosure provides apparatuses and methods for validating SIB1 request configurations.

In one embodiment, a user equipment (UE) is provided. The UE includes a transceiver configured to, while the UE is in an RRC_CONNCECTED state, receive, from a primary cell (PCell), a system information block (SIB) including a SIB1 request configuration of one or more cells. The UE also includes a processor operably coupled to the transceiver. The processor is configured to, upon a radio link failure, start a timer T311, and while the timer T311 is running, select a cell. The transceiver is further configured to transmit a SIB1 request to the selected cell in response to a determination by the processor that (i) the selected cell provides SIB1 on demand and (ii) the SIB including the SIB1 request configuration of the one or more cells includes a SIB1 request configuration of the selected cell.

In another embodiment, a base station (BS) is provided. The BS includes a processor, and a transceiver operably coupled to the processor. The transceiver is configured to while a UE is in an RRC_CONNCECTED state, transmit, a SIB including a SIB1 request configuration of one or more cells, and receive a SIB1 request from the UE. A cell of the BS is a PCell of the UE, the BS provides SIB1 on demand, and the SIB1 request configuration of the one or more cells includes a SIB1 request configuration of a cell of the BS.

In yet another embodiment, a method of a operating a UE is provided. The method includes while the UE is in an RRC_CONNCECTED state, receiving, from a PCell, a SIB including a SIB1 request configuration of one or more cells. The method also includes upon a radio link failure, starting a timer T311, and while the timer T311 is running, selecting a cell. The method further includes transmitting a SIB1 request to the selected cell in response to a determination that (i) the selected cell provides SIB1 on demand and (ii) the SIB including the SIB1 request configuration of the one or more cells includes a SIB1 request configuration of the selected cell.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example offset according to embodiments of the present disclosure;

FIG. 5 illustrates an example of multiple offsets according to embodiments of the present disclosure;

FIG. 6 illustrates an example offset according to embodiments of the present disclosure;

FIG. 7 illustrates an example procedure for RRC connection re-establishment according to embodiments of the present disclosure;

FIG. 8 illustrates an example procedure for camping to a cell according to embodiments of the present disclosure;

FIG. 9 illustrates an example procedure for a SIB1 request according to embodiments of the present disclosure;

FIG. 10 illustrates an example procedure for camping in a cell according to embodiments of the present disclosure;

FIG. 11 illustrates an example procedure for PO monitoring according to embodiments of the present disclosure;

FIG. 12 illustrates an example procedure for LP WUS monitoring according to embodiments of the present disclosure;

FIG. 13 illustrates an example method for validating a SIB1 request configuration according to embodiments of the present disclosure; and

FIG. 14 illustrates an example method for validating a SIB1 request configuration according to embodiments of the present disclosure.

### DETAILED DESCRIPTION

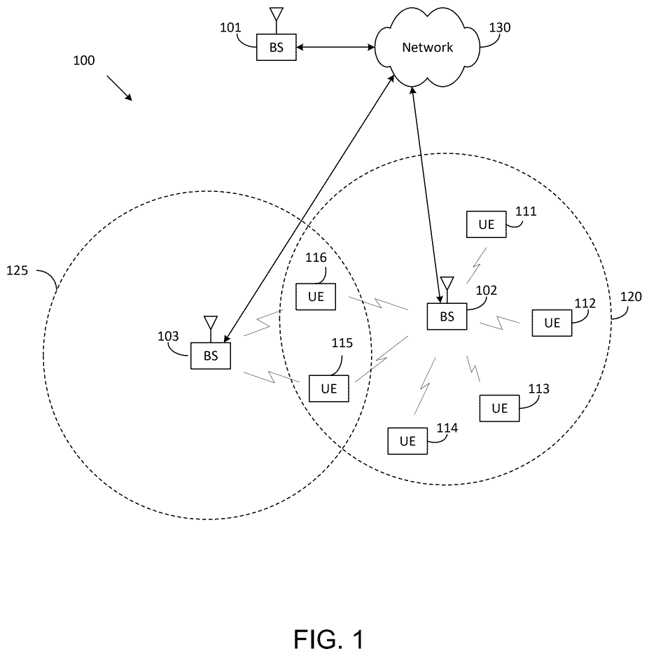

FIGS. 1 through 14, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for validating SIB1 request configurations. In certain embodiments, one or more of the gNBs 101-103 includes circuitry, programing, or a combination thereof, to support validating SIB1 request configurations in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

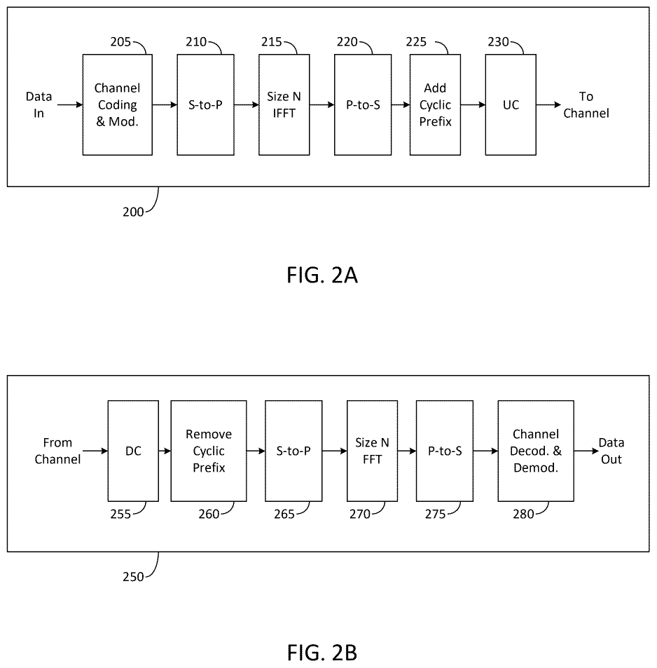

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support validating SIB1 request configurations as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

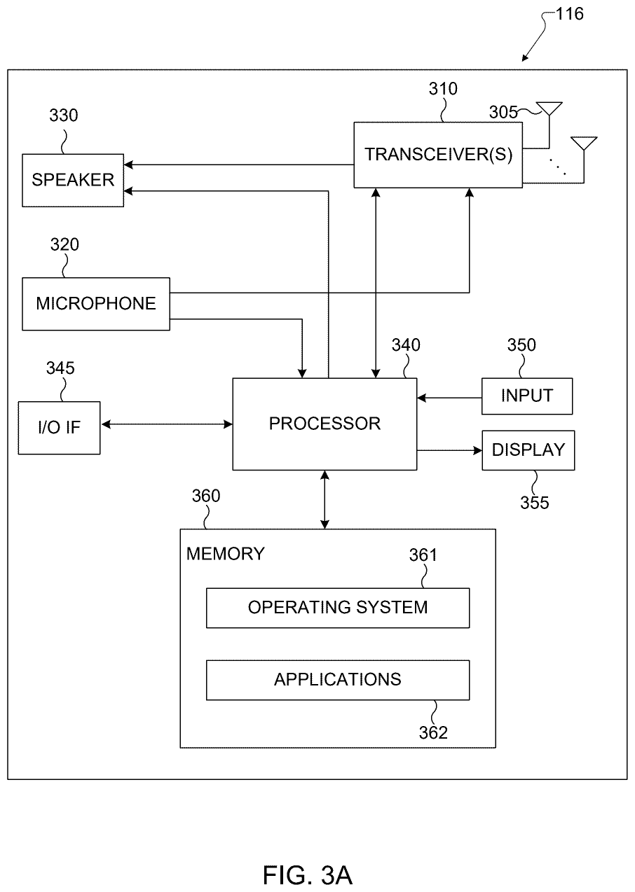

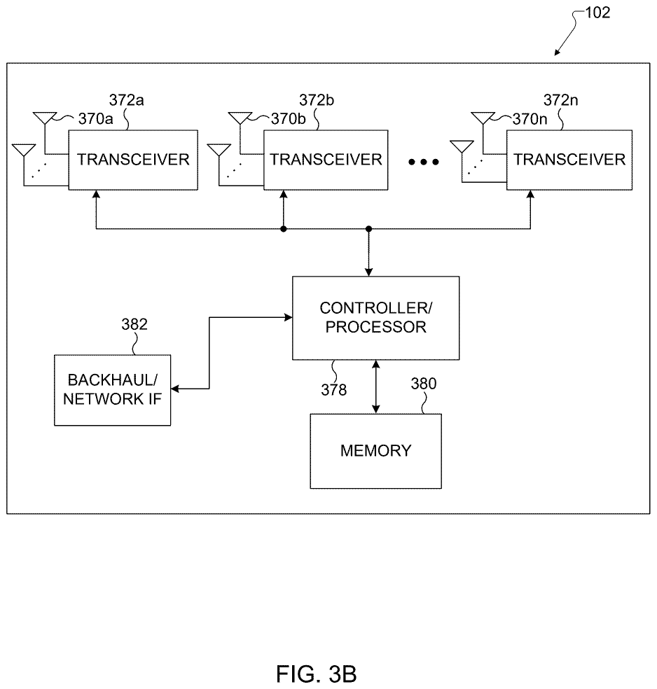

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for validating SIB1 request configurations as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support validating SIB1 request configurations as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted, and additional components could be added according to particular needs.

The next generation wireless communication system (e.g., 5G, beyond 5G, 6G) supports not only lower frequency bands but also higher frequency (mmWave) bands (e.g., 10 GHz to 100 GHz bands), so as to accomplish higher data rates. To mitigate propagation loss of the radio waves and increase the transmission distance, beamforming, massive Multiple-Input Multiple-Output (MIMO), Full Dimensional MIMO (FD-MIMO), array antenna, analog beam forming, and large scale antenna techniques are being considered in the design of the next generation wireless communication system. In addition, the next generation wireless communication system is expected to address different use cases having quite different requirements in terms of data rate, latency, reliability, mobility etc. However, it is expected that the design of the air-interface of the next generation wireless communication system would be flexible enough to serve UEs having quite different capabilities depending on the use case and market segment the UE caters service to the end customer. A few example use cases the next generation wireless communication system wireless system is expected to address is enhanced Mobile Broadband (eMBB), massive Machine Type Communication (m-MTC), ultra-reliable low latency communication (URLL), etc. eMBB requirements like tens of Gbps data rate, low latency, high mobility, etc. address the market segment representing conventional wireless broadband subscribers needing internet connectivity everywhere, all the time and on the go. m-MTC requirements like very high connection density, infrequent data transmission, very long battery life, low mobility, etc. address the market segment representing Internet of Things (IoT)/Internet of Everything (IoE) envisioning connectivity of billions of devices. URLL requirements like very low latency, very high reliability and variable mobility, address the market segment representing industrial automation applications, and vehicle-to-vehicle/vehicle-to-infrastructure communication, which is foreseen as one of the enablers for autonomous cars.

In the next generation wireless communication system (e.g., 5G, beyond 5G, 6G) operating in higher frequency (mmWave) bands, UEs and gNBs communicate with each other using beamforming. Beamforming techniques are used to mitigate propagation path losses and to increase the propagation distance for communication at higher frequency bands. Beamforming enhances transmission and reception performance using a high-gain antenna. Beamforming can be classified into transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in an increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can be also referred to as a TX beam. Wireless communication systems operating at high frequency use a plurality of narrow TX beams to transmit signals in the cell, as each narrow TX beam provides coverage to a part of the cell. The narrower the TX beam, the higher the antenna gain and hence the larger the propagation distance of a signal transmitted using beamforming. A receiver can also generate a plurality of RX beam patterns of different directions. Each of these receive patterns can also be referred to as an RX beam.

The next generation wireless communication system (e.g., 5G, beyond 5G, 6G) supports standalone modes of operation as well dual connectivity (DC). In DC a multiple Rx/Tx UE may be configured to utilize resources provided by two different nodes (or NBs) connected via non-ideal backhaul. One node acts as the Master Node (MN) and the other nodes acts as the Secondary Node (SN). The MN and SN are connected via a network interface and at least the MN is connected to the core network (CN). NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with carrier aggregation (CA)/DC there is only one serving cell comprising the primary cell. For a UE in an RRC_CONNECTED state configured with CA/DC the term ‘serving cells’ is used to denote the set of cells comprising the Special Cell(s) (SpCell[s]) and all secondary cells (SCells). In NR the term Master Cell Group (MCG) refers to a group of serving cells associated with the Master Node, comprising the primary cell (PCell) and optionally one or more (SCells. In NR the term Secondary Cell Group (SCG) refers to a group of serving cells associated with the Secondary Node, comprising the primary SCG cell (PSCell) and optionally one or more SCells. In NR, PCell refers to a serving cell in a MCG, operating on the primary frequency, in which the UE either performs the initial connection establishment procedure or initiates the connection re-establishment procedure. In NR, for a UE configured with CA, an SCell is a cell providing additional radio resources on top of the SpCell. PSCell refers to a serving cell in a SCG in which the UE performs random access when performing the Reconfiguration with Sync procedure. For Dual Connectivity operation the term SpCell refers to the PCell of the MCG or the PSCell of the SCG. Otherwise, the term SpCell refers to the PCell.

In the next generation wireless communication system (e.g., 5G, beyond 5G, 6G), a next generation node B (gNB) or base station in cell broadcast Synchronization Signal and physical broadcast channel (PBCH) block (SSB) comprises primary and secondary synchronization signals (PSS, SSS) and system information (SI). SI includes common parameters needed to communicate in cell. In the fifth generation wireless communication system (also referred to as next generation radio or NR), SI is divided into the master information block (MIB) and a number of s (SIBs) where: the MIB is always transmitted on the broadcast channel (BCH) with a periodicity of 80 ms and repetitions made within 80 ms and the MIB includes parameters that are used to acquire SIB1 from the cell. The SIB1 is transmitted on the downlink shared channel (DL-SCH) with a periodicity of 160 ms and variable transmission repetition. The default transmission repetition periodicity of SIB1 is 20 ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to SI messages, periodicity, SI-window size) of other SIBs with an indication whether one or more SIBs are only provided on-demand and, in that case, the configuration needed by the UE to perform the SI request. SIB1 is a cell-specific SIB. SIBs other than SIB1 and positioning SIBs (posSIBs) are carried in SystemInformation (SI) messages, which are transmitted on the DL-SCH. Only SIBs or posSIBs having the same periodicity can be mapped to the same SI message. SIBs and posSIBs are mapped to the different SI messages. Each SI message is transmitted within periodically occurring time domain windows (referred to as SI-windows with the same length for all SI messages). Each SI message is associated with an SI-window, and the SI-windows of different SI messages do not overlap. That is to say, within one SI-window only the corresponding SI message is transmitted. An SI message may be transmitted a number of times within the SI-window. Any SIB or posSIB except SIB1 can be configured to be cell specific or area specific, using an indication in the SIB1. A cell specific SIB is applicable only within a cell that provides the SIB while an area specific SIB is applicable within an area referred to as an SI area, which comprises one or several cells and is identified by systemInformationAreaID. The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message. For a UE in an RRC_CONNECTED state, the network can provide system information through dedicated signaling using an RRCReconfiguration message (e.g., if the UE has an active BWP with no common search space configured to monitor system information), paging, or upon request from the UE. In an RRC_CONNECTED state, the UE acquires the required SIB(s) only from the PCell. For PSCell and SCells, the network provides the required SI by dedicated signaling (i.e., within an RRCReconfiguration message). Nevertheless, the UE shall acquire the MIB of the PSCell to get system frame number (SFN) timing of the SCG (which may be different from MCG). Upon a change of relevant SI for the SCell, the network releases and adds the concerned SCell. For the PSCell, the required SI can only be changed with Reconfiguration with Sync.

In the next generation wireless communication system (e.g., 5G, beyond 5G (B5G), 6G), random access (RA) is supported. RA is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by non-synchronized UE in RRC_CONNECTED state. Several types of random-access procedure are supported such as contention based random access, contention free random access and each of these can be one of 2 step or 4 step random access.

In the next generation wireless communication system (e.g., 5G, beyond 5G, 6G), A physical downlink control channel (PDCCH) is used to schedule DL transmissions on a physical downlink shared channel (PDSCH) and UL transmissions on a physical uplink shared channel (PUSCH), where Downlink Control Information (DCI) on the PDCCH includes: downlink assignments containing at least modulation and coding format, resource allocation, and hybrid-ARQ information related to DL-SCH; and uplink scheduling grants containing at least modulation and coding format, resource allocation, and hybrid-ARQ information related to UL-SCH. In addition to scheduling, the PDCCH can be used to for: activation and deactivation of configured PUSCH transmission with configured grant; activation and deactivation of PDSCH semi-persistent transmission; notifying one or more UEs of the slot format; notifying one or more UEs of the physical resource block(s) (PRB[s]) and OFDM symbol(s) where the UE may assume no transmission is intended for the UE; transmission of transmit power control (TPC) commands for the physical uplink control channel (PUCCH) and PUSCH; transmission of one or more TPC commands for sounding reference signal (SRS) transmissions by one or more UEs; switching a UE's active bandwidth part; and initiating a random access procedure. A UE monitors a set of PDCCH candidates in the configured monitoring occasions in one or more configured Control REsource SETs (CORESETs) according to the corresponding search space configurations. A CORESET comprises a set of PRBs with a time duration of 1 to 3 OFDM symbols. The resource units Resource Element Groups (REGs) and Control Channel Elements (CCEs) are defined within a CORESET with each CCE comprising a set of REGs. Control channels are formed by aggregation of CCEs. Different code rates for the control channels are realized by aggregating a different number of CCEs. Interleaved and non-interleaved CCE-to-REG mappings are supported in a CORESET. Polar coding is used for the PDCCH. Each resource element group carrying the PDCCH carries its own demodulation reference signal (DMRS). Quadrature phase shift keying (QPSK) modulation is used for the PDCCH.

In the next generation wireless communication system (e.g., 5G, beyond 5G, 6G), a list of search space configurations is signaled by the gNB for each configured BWP of the serving cell, wherein each search configuration is uniquely identified by a search space identifier. Each search space identifier is unique amongst the BWPs of a serving cell. An identifier of a search space configuration to be used for a specific purpose such as paging reception, SI reception, random access response reception, etc. is explicitly signaled by the gNB for each configured BWP. In NR, a search space configuration comprises the parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+duration, where the slot with number ‘x’ in a radio frame with number ‘y’ satisfies the equation below:

$$( y ⋆ ( number of slots in a radio frame ) + x - Monitoring - offset - PDCCH - slot ) mod ( Monitoring - periodicity - PDCCH - slot ) = 0.$$

The starting symbol of a PDCCH monitoring occasion in each slot having a PDCCH monitoring occasion is given by Monitoring-symbols-PDCCH-within-slot. The length (in symbols) of a PDCCH monitoring occasion is given in the CORESET associated with the search space. The search space configuration includes the identifier of the CORESET configuration associated with it. A list of CORESET configurations is signaled by the gNB for each configured BWP of the serving cell, wherein each CORESET configuration is uniquely identified by a CORESET identifier. A CORESET identifier is unique amongst the BWPs of a serving cell. Note that each radio frame is of 10 ms duration. A radio frame is identified by a radio frame number or system frame number. Each radio frame comprises several slots, wherein the number of slots in a radio frame and duration of slots depends on sub carrier spacing (SCS). The number of slots in a radio frame and duration of slots depends on radio frame for each supported SCS is pre-defined in NR. Each CORESET configuration is associated with a list of Transmission configuration indicator (TCI) states. One DL reference signal (RS) identification (ID) (SSB or channel state information [CSI] RS) is configured per TCI state. The list of TCI states corresponding to a CORESET configuration is signaled by the gNB via radio resource control (RRC) signaling. One of the TCI states in a TCI state list is activated and indicated to the UE by the gNB. The TCI state indicates the DL TX beam (the DL TX beam is quasi co-located [QCLed] with the SSB/CSI RS of the TCI state) used by the gNB for transmission of the PDCCH in the PDCCH monitoring occasions of a search space.

In the next generation wireless communication system (e.g., 5G, beyond 5G, 6G), bandwidth adaptation (BA) is supported. With BA, the receive and transmit bandwidth of a UE need not be as large as the bandwidth of the cell and can be adjusted: the width can be ordered to change (e.g., to shrink during a period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active one. When BA is configured, the UE can monitor the PDCCH only on the one active BWP (i.e., the does not have to monitor the PDCCH on the entire DL frequency of the serving cell). In an RRC connected state, the UE is configured with one or more DL and UL BWPs, for each configured Serving Cell (i.e., PCell or SCell). For an activated Serving Cell, there is always one active UL and DL BWP at any point in time. BWP switching for a Serving Cell is used to activate an inactive BWP and deactivate an active BWP at a particular moment in time. BWP switching is controlled by the PDCCH indicating a downlink assignment or an uplink grant, by the bwp-InactivityTimer, by RRC signaling, or by the MAC entity itself upon initiation of a random-access procedure. Upon addition of a SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either RRC or the PDCCH. For unpaired spectrum, a DL BWP is paired with a UL BWP, and BWP switching is common for both the UL and DL. Upon expiry of the BWP inactivity timer, the UE switches the active DL BWP to the default DL BWP or initial DL BWP (if a default DL BWP is not configured).

In the next generation wireless communication system (e.g., 5G, beyond 5G (B5G), 6G), a UE can be in one of the following RRC states: RRC IDLE, RRC INACTIVE and RRC CONNECTED. Paging allows the network to reach UEs in the RRC_IDLE and in RRC_INACTIVE state through Paging messages, and to notify UEs in the RRC_IDLE, RRC_INACTIVE and RRC_CONNECTED state of system information changes and ETWS (Earthquake and Tsunami Warning System)/CMAS (Commercial Mobile Alert System) indications through Short Messages. Both Paging messages and Short Messages are addressed with a paging radio network terminal identifier (P-RNTI) on the PDCCH, but while the former is sent on a paging common logical channel (PCCH) (a transport block [TB] carrying the paging message is transmitted over the PDSCH [Physical downlink shared channel])), the latter is sent over the PDCCH directly.

The UE may use Discontinuous Reception (DRX) in the RRC_IDLE and RRC_INACTIVE state in order to reduce power consumption. The UE monitors one paging occasion (PO) per DRX cycle. A PO is a set of PDCCH monitoring occasions and can comprise multiple time slots (e.g., subframes or OFDM symbols) where paging DCI (i.e., PDCCH addressed to a P-RNTI) can be sent. One Paging Frame (PF) is one Radio Frame and may contain one or multiple PO(s) or a starting point of a PO. A PO associated with a PF may start in the PF or after the PF.

The PF and PO for paging are determined (by the UE and base station e.g., gNB) by the following formulae:
System frame number (SFN) for the PF is determined by:

$$( S F N + PF\_offset ) mod T = ( T div N ) ⋆ ( UE\_ID mod N )$$

Index (i_s), indicating the index of the PO is determined by:

$$i\_s = floor ( UE\_ID / N ) mod / Ns$$

The following parameters are used for the calculation of PF and i_s above:
T: DRX cycle of the UE.
N: number of total paging frames in T; N is one of T, T/2, T/4, T/8, T/16
Ns: number of paging occasions for a PF; NS is one of 1, 2, 4
PF offset: offset used for PF determination
UE_ID:
If the UE operates in enhanced DRX (eDRX):
   5G-S-TMSI (5G serving temporary mobile subscriber identity) mod 4096
otherwise:
   5G-S-TMSI mod 1024

In order to reduce UE power consumption due to false paging alarms, the group of UEs monitoring the same PO can be further divided into multiple subgroups. With subgrouping, a UE shall monitor the PDCCH in its PO for paging if the subgroup to which the UE belongs is paged as indicated via an associated Paging Early Indication (PEI). If a UE cannot find its subgroup ID with the PEI configurations in a cell or if the UE is unable to monitor the associated PEI occasion corresponding to its PO, it shall monitor the paging in its PO.

Paging with CN assigned subgrouping is used in the cell which supports CN assigned subgrouping. A UE supporting CN assigned subgrouping in an RRC_IDLE or RRC_INACTIVE state can be assigned a subgroup ID (between 0 to 7) by an access management function (AMF) through network access stratum (NAS) signaling.

The UE monitors one PEI occasion per DRX cycle. A PEI occasion (PEI-O) is a set of PDCCH monitoring occasions (MOs) and can include multiple time slots (e.g., subframes or OFDM symbols) where a PEI can be sent. In multi-beam operations, the UE assumes that the same PEI is repeated in all transmitted beams and thus the selection of the beam(s) for the reception of the PEI is up to UE implementation. The time and location of a PEI-O for a UE's PO is determined by a reference point and an offset:
The reference point is the start of a reference frame determined by a frame-level offset from the start of the first PF of the PF(s) associated with the PEI-O, provided by pei-FrameOffset in SIB1; The first PF of the PFs associated with the PEI-O is provided by (SFN for PF)-floor (i_{PO}/Ns)*T/N; where

$${i}_{P O} = ( ( UE\_ID mod N ) \cdot {N}_{S} + i\_s ) mod {N}_{P O}^{PEI}$$

is a paging occasion index,

$${N}_{P O}^{PEI} ,$$

is signaled by po-NumPerPEI.
The offset is a symbol-level offset from the reference point to the start of the first PDCCH MO of this PEI-O, provided by firstPDCCH-MonitoringOccasionOfPEI-O in SIB1.

Currently, UEs periodically wake up once per DRX cycle, which dominates the power consumption in periods with no signaling or data traffic. If UEs are able to wake up only when they are triggered (e.g., paging), power consumption could be dramatically reduced. This can be achieved by using a wake-up signal to trigger the main radio (MR) and a separate low power wakeup receiver (LR) which has the ability to monitor for a wake-up signal with ultra-low power consumption. The main radio is then used for data transmission and reception, which can be turned off or set to deep sleep unless it is turned on. A low power wakeup receiver and wakeup signal design is being studied to minimize UE power consumption. The low power wakeup receiver (LR) is expected to consume 1/100 of the power consumed by the MR. It is expected that a UE in an RRC_IDLE or RRC_INACTIVE state will monitor a low power wakeup signal (LP WUS) using the LR if the UE and camped cell supports the LP WUS. The gNB transmits the low power wakeup signal in an LP WUS occasion (LO) when the gNB needs to send RAN paging or CN paging to the UE or SI/emergency notifications to the UE.

If the LP WUS is received, the UE wakes up the MR and monitors its PO (using the MR) and receives pa aging message (if scheduled by the monitored PO).

The UE may need a certain time to wakeup MR and monitor PO. The wakeup delay depends on UE capability. The UE may report the wakeup delay to monitor its PO to the gNB.

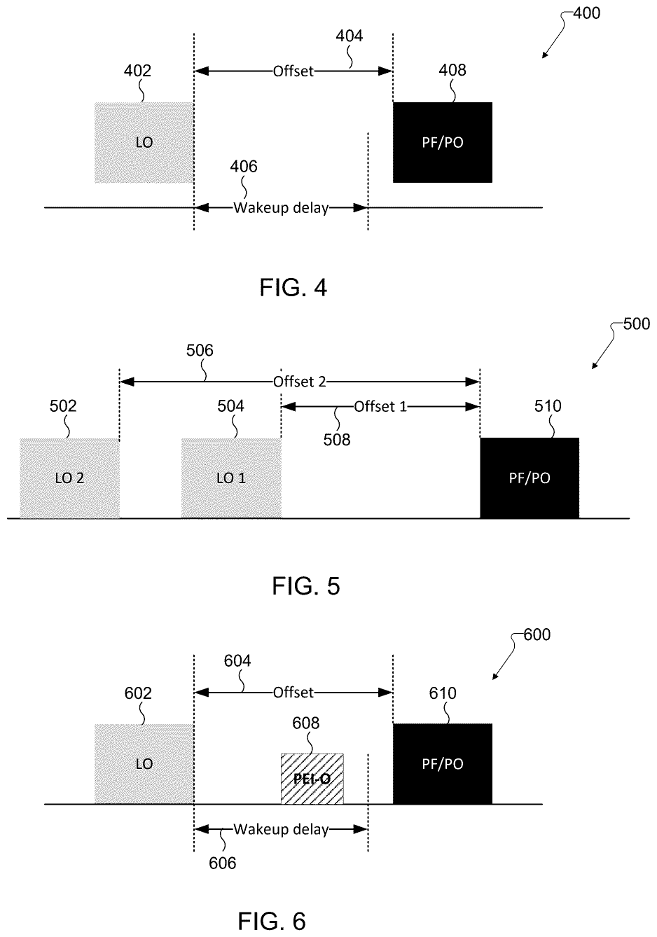

The gNB configures an offset between the LO and PF/PO as shown in FIG. 4.

FIG. 4 illustrates an example offset 400 according to embodiments of the present disclosure. The embodiment of an offset of FIG. 4 is for illustration only. Different embodiments of an offset could be used without departing from the scope of this disclosure.

In the example of FIG. 4, a gNB (such as gNB 102) transmits an LO 402. After an offset 404 longer than a wakeup delay 406, the gNB transmits a PF/PO. 408.

Although FIG. 4 illustrates one example offset 400, various changes may be made to FIG. 4. For example, various changes to the offset length could be made, etc. according to particular needs.

The UE monitors the LO if the gap between the LO and the UE's PF/PO is no less than the wake-up delay (i.e., the UE monitors the LO for which the gap between the LO and the UE's PF/PO is greater than or equal to the wake-up delay). Otherwise, the UE does not monitor LP WUS and follows legacy paging procedure.

The gNB can configure two offset values between the LO and PF/PO as shown in FIG. 5.

FIG. 5 illustrates an example of multiple offsets 500 according to embodiments of the present disclosure. The embodiment of an offset of FIG. 5 is for illustration only. Different embodiments of multiple offsets could be used without departing from the scope of this disclosure.

In the example of FIG. 5, a gNB (not shown) transmits an LO 402 (“LO 2”) followed by an LO 504 (“LO 1”). After an offset 506 (“Offset 2”) from LO 502 and an offset 508 (“Offset 1”) from 508, the gNB transmits a PF/PO 510.

Although FIG. 5 illustrates one example of multiple offsets 500, various changes may be made to FIG. 5. For example, various changes to the offset lengths could be made, etc. according to particular needs.

If multiple offset values are configured and if the gap between the LO (i.e., LO2 in FIG. 5) associated with the largest offset value and the corresponding PF/PO is no less than the wake-up delay a UE reports, the UE monitors the LO (i.e., LO1 in FIG. 5) associated with the smallest offset value that has a gap between the LO and the PFPO no less than the wake-up delay. Otherwise, the UE does not monitor the LP WUS and follows legacy paging procedure.

In a cell where the paging early indication (PEI) is supported in addition to LP WUS, if a UE supports PEI, the will monitor for a PEI (in a PEI-O) after receiving the LP WUS. Existing networks do not define how the UE determines which LO to monitor. A PEI-O occurs before a PO. The UE may monitor the PO after receiving a PEI, if paging is there for the UE based on the PEI. If the UE determines an LO based on a PO, there may not be sufficient time to wake up for the PEI-O due to an insufficient gap between the PO and PEI-O, similar as shown in FIG. 6.

FIG. 6 illustrates an example offset 600 according to embodiments of the present disclosure. The embodiment of an offset of FIG. 6 is for illustration only. Different embodiments of an offset could be used without departing from the scope of this disclosure.

In the example of FIG. 6, a gNB (such as gNB 102) transmits an LO 602. During an offset 604 longer than a wakeup delay 606, but before completion of the wakeup delay 606, a PEI-O 608 occurs. The gNB transmits a PF/PO. 610 after offset 604. The offset 604 may be, for example 20 ms, and the wakeup delay 606 may be, for example, 18 ms, while the gap between the PEI-O 608 and the PF/PO 610 may be 5 ms. In this example, the gap between LO 602 and PEI-O 608 is less than wakeup delay 606.

Although FIG. 6 illustrates one example offset 600, various changes may be made to FIG. 6. For example, various changes to the offset length could be made, etc. according to particular needs.

Various embodiments of the present disclosure provide mechanisms for a UE to determine an LO to monitor for an LP WUS.

SIB1 is periodically transmitted in a cell by a gNB. SIB1 periodicity is 160 ms with repetition at every 20 ms within the 160 ms interval. Periodic transmissions lead to increased network energy consumption. On demand SIB1 can enhance network energy savings wherein a cell can transmit SIB1 upon receiving request from a UE instead of periodically broadcasting SIB1. A configuration to request SIB1 for one or more cells can be transmitted by cell in a SIB (e.g., “SIBx”). While the UE is in an RRC_IDLE/RRC_INACTIVE state, the UE acquires SIBx from the camped cell and applies SIBx for requesting SIB1 in the currently camped cell or in a candidate cell selected for cell reselection.

While the UE is in an RRC_CONNECTED state and radio link failure (RLF) occurs, the UE needs to acquire SIB1 of a selected cell for RRC connection re-establishment. If SIB1 is provided on demand, the UE needs to request SIB1. However, the SIB1 request configuration which the UE has previously acquired while the UE was in an RRC_IDLE/RRC_INACTIVE state may not be valid.

In another scenario, a UE is in an RRC_CONNECTED state and receives an RRC release message to release RRC_CONNECTION and enter an RRC_IDLE state. The UE performs cell selection as part of entering an RRC_IDLE state. The UE needs to acquire SIB1 of selected cell. If SIB1 is provided on demand, the UE needs to request SIB1. However, the SIB1 request configuration which the UE has previously acquired while the UE was in an RRC_IDLE/RRC_INACTIVE state may not be valid.

In another scenario, while the UE is in an RRC_IDLE/RRC_INACTIVE state, the UE acquires SIBx from the camped cell. SIBx may include a SIB1 request configuration of one or more cells. The UE can apply the SIB1 request configuration for requesting SIB1 in the currently camped cell or in a candidate cell selected for cell reselection. Upon cell reselection, the UE needs to reacquire SIBx again as the UE does not know how long the previously acquired SIBx is valid. If a reselected cell does not support SIBx, the UE may not be able to perform SIB1 request in the subsequent cell reselection.

Various embodiments of the present disclosure provide mechanisms for a UE to request a SIB1 upon a cell selection/reselection.

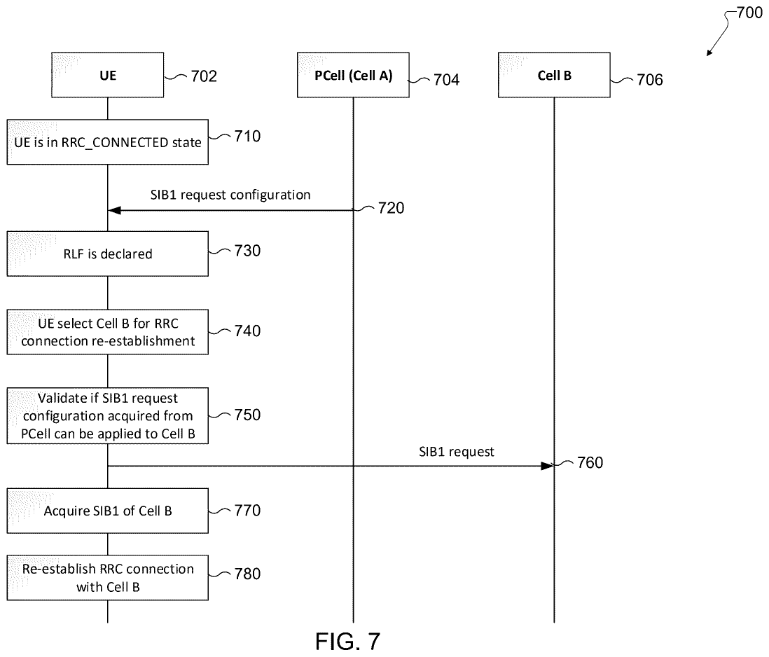

FIG. 7 illustrates an example procedure for RRC connection re-establishment 700 according to embodiments of the present disclosure. An embodiment of the procedure illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of a procedure for RRC connection re-establishment could be used without departing from the scope of this disclosure.

In the example of FIG. 7, the RRC connection re-establishment procedure 700 is an example of an RRC connection re-establishment to a cell that supports providing SIB1 on demand (i.e., not periodically broadcasting SIB1, but instead broadcasting SIB1 upon SIB1 request).

Procedure 700 begins at operation 710, where a UE 702 is in an RRC_CONNECTED state and communicating with a PCell 704 (“Cell A”). At operation 720, the UE 702 acquires a SIB1 request configuration of one or more cell(s) while the UE 702 is in the RRC_CONNECTED state.

In some embodiments, if an active BWP supports a common search space with the field searchSpaceOther SystemInformation, UE 702 may acquire a SIB broadcast by the Cell A wherein the acquired SIB includes a SIB1 request configuration of one or more cell(s). In embodiments such as these, the UE 702 may acquire the SIB if UE 702 does not have a valid stored version of the SIB which the Cell A supports.

Alternatively, in some embodiments, UE 702 may receive a SIB in a dedicated signaling message from Cell A, wherein the acquired SIB includes the SIB1 request configuration of one or more cell(s). In embodiments such as these, Cell A may send the SIB including the SIB1 request configuration of one or more cell(s) in dedicated a signaling message if the common search space with the field searchSpaceOtherSystemInformation is not configured in the active BWP.

Alternatively, in some embodiments, UE 702 may send an RRC system information request message including a request for a SIB which includes a SIB1 request configuration of one or more cell(s). In embodiments such as these, Cell A may send the SIB including a SIB1 request configuration of one or more cell(s) in a dedicated signaling message after receiving the request. UE 702 may send the request if an active BWP is not configured with a common search space with the field searchSpaceOtherSystemInformation and UE 702 does not have a valid stored version of a SIB which the Cell A supports and onDemandSIB-Request is configured and timer T350 is not running (and/or a request for a SIB including a SIB1 request configuration of one or more cell(s) is configured).

At operation 730, a radio link failure (RLF) is declared in the RRC_CONNECTED state. A radio link failure can be declared for various reasons, such as upon T310 expiry in PCell 704; upon T312 expiry in PCell 704; or upon a random access problem indication from a MCG MAC while neither T300, T301, T304, T311 nor T319 are running and a small data transmission (SDT) procedure is not ongoing); or upon indication from a MCG RLC that the maximum number of retransmissions has been reached while an SDT procedure is not ongoing; or if connected as an IAB-node, upon BH RLF indication received on a BAP entity from the MCG; or upon consistent uplink LBT failure indication from MCG MAC while T304 is not running.

Upon declaration of the RLF, at operation 740 the UE 702 starts a timer T311 and selects a cell 706 (“Cell B”) while T311 is running.

At operation 750, if the UE 702 determines that Cell B provides SIB1 on demand (i.e., not periodically broadcasting SIB1, broadcasting/transmitting SIB1 upon SIB1 request), at operation 760 UE 702 sends a SIB1 request to Cell B. For example, UE 702 may determine whether Cell B provides SIB1 on demand based on information in a MIB of Cell B (UE 702 acquiring the MIB before acquiring SIB1).

In some embodiments, UE 702 may send the SIB1 request to Cell B if the (last) SIB1 request configuration (e.g., SIBx, a SIB which includes a SIB1 request configuration) acquired from Cell A (or alternately a Cell C other than Cell A) includes a SIB1 request configuration of Cell B.

Alternatively, in some embodiments, UE 702 may send the SIB1 request to Cell B, if the (last) SIB1 request configuration (e.g., SIBx, a SIB which include SIB1 request configuration) acquired from Cell A (or alternately Cell C other than Cell A) includes SIB1 request configuration of Cell B and the SIB1 request configuration (e.g., SIBx, a SIB which includes a SIB1 request configuration) was acquired in the current modification period.

Alternatively, in some embodiments, UE 702 may send a SIB1 request to Cell B, if the (last) SIB1 request configuration (e.g., SIBx, a SIB which includes a SIB1 request configuration) acquired from Cell A (or alternately Cell C other than Cell A) includes a SIB1 request configuration of Cell B and the SIB1 request configuration (e.g., SIBx) is valid in the current modification period.
The SIB1 request configuration (e.g., SIBx) can be valid in the current modification period, if it was acquired in the current modification period.
The SIB1 request configuration (e.g., SIBx) can be valid in the current modification period (N), if an SI change notification was received in the previous modification period (N−1) and the SIB1 acquired in the current modification period indicates that the valueTag of SIBx is same as the valueTag of the last acquired SIBx.
The SIB1 request configuration (e.g., SIBx) can be valid in the current modification period (N), if an SI change notification was not received in previous modification period (N−1).
The SIB1 request configuration (e.g., SIBx) can be valid in the current modification period (N), if the UE 702 already had/maintained the SIB1 request configuration (e.g., SIBx) and if an SI change notification was received in previous modification period (N−1) and a SIB1 acquired in current modification period indicates that the valueTag of the SIBx is the same as the valueTag of last acquired SIBx.
The SIB1 request configuration (e.g., SIBx) can be valid in the current modification period (N), if the UE 702 already had/maintained the SIB1 request configuration (e.g., SIBx) and if an SI change notification was not received in previous modification period (N−1).

Alternatively, in some embodiments, UE 702 may send the SIB1 request to Cell B, if the (last) SIB1 request configuration (e.g., SIBx, a SIB which includes a SIB1 request configuration) acquired from Cell A (or alternately a Cell C other than Cell A) includes a SIB1 request configuration of Cell B and the timer T311 was started in same modification period in which the UE 702 has acquired the SIB1 request configuration.

Alternatively, in some embodiments, UE 702 may send the SIB1 request to Cell B, if the (last) SIB1 request configuration (e.g., SIBx, a SIB which includes a SIB1 request configuration) acquired from Cell A (or alternately a Cell C other than Cell A) includes a SIB1 request configuration of Cell B and the current time belongs to same modification period in which the UE 702 has acquired the SIB1 request configuration.

Alternatively, in some embodiments, UE 702 may send the SIB1 request to Cell B, if the (last) SIB1 request configuration (e.g., SIBx, a SIB which includes a SIB1 request configuration) acquired from Cell A (or alternately a Cell C other than Cell A) includes a SIB1 request configuration of Cell B and the time for initiating SIB1 request/transmit SIB1 request belongs to same modification period in which the UE 702 has acquired the SIB1 request configuration.

Alternatively, in some embodiments, UE 702 may send the SIB1 request to Cell B, if the (last) SIB1 request configuration (e.g., SIBx, a SIB which includes a SIB1 request configuration) acquired from Cell A (or alternately a Cell C other than Cell A) includes a SIB1 request configuration of Cell B and timer T is running wherein the timer T is (re-)started when the SIB1 request configuration of Cell B was received. The value of the timer T may be received in SIB including SIB1 request configuration of Cell B or in any other SIB or RRC message. Timer T can be separately configured per SIB1 request configuration included in the SIB or timer T can be commonly configured for all SIB1 request configurations included in the SIB.

Alternatively, in some embodiments, UE 702 may send the SIB1 request to Cell B, if the (last) SIB1 request configuration (e.g., SIBx, a SIB which includes a SIB1 request configuration) acquired from Cell A (or alternately a Cell C other than Cell A) includes a SIB1 request configuration of Cell B and current real time (e.g., UTC time) is earlier than the UTC time until which the acquired SIB1 request configuration of Cell B is valid. The real time (e.g., UTC) time until which the acquired SIB1 request configuration of Cell B is valid may be received in a SIB including a SIB1 request configuration of Cell B. This validity time can be separately configured per SIB1 request configuration included in the SIB or can be commonly configured for all SIB1 request configurations included in the SIB.

Alternatively, in some embodiments, UE 702 may send the SIB1 request to Cell B, if the (last) SIB1 request configuration (e.g., SIBx, a SIB which includes a SIB1 request configuration) acquired from Cell A (or alternately a Cell C other than Cell A) includes a SIB1 request configuration of Cell B and the current real time (e.g., UTC) time is earlier than the UTC time until which the acquired SIB1 request configuration of Cell B is valid. The SIB1 request configuration of Cell B is valid from T1 to T1+T2. The real time (e.g., UTC) time T1 from which the acquired SIB1 request configuration of Cell B becomes valid may be received in a SIB including a SIB1 request configuration of Cell B. This time T1 can be separately configured per SIB1 request configuration included in the SIB or can be commonly configured for all SIB1 request configurations included in the SIB. The timer T2 until which the acquired SIB1 request configuration of Cell B is valid may be received in SIB including SIB1 request configuration of Cell B or in another SIB1 or RRC message. This time T2 can be separately configured per SIB1 request configuration included in the SIB or can be commonly configured for all SIB1 request configurations included in the SIB.

At operation 770, UE 702 acquires the SIB1 of Cell B in response to the SIB1 request at operation 760. At operation 780, UE 702 re-establishes its RRC connection with Cell B.

Although FIG. 7 illustrates one example procedure for RRC connection re-establishment 700, various changes may be made to FIG. 7. For example, while shown as a series of operations, various operations in FIG. 7 could overlap, occur in parallel, occur in a different order, occur any number of times, be omitted, or replaced by other operations.

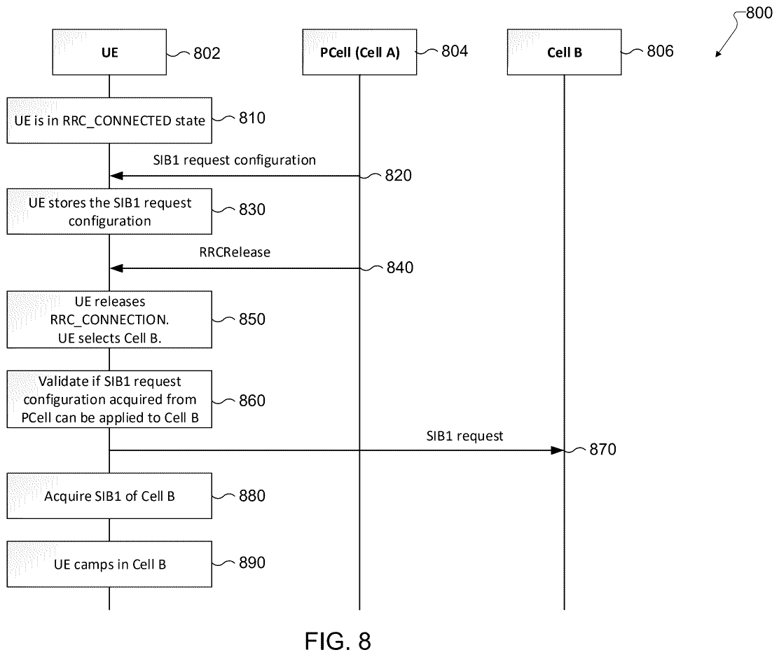

FIG. 8 illustrates an example procedure for camping to a cell 800 according to embodiments of the present disclosure. An embodiment of the procedure illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a procedure for camping to a cell could be used without departing from the scope of this disclosure.

In the example of FIG. 8, the procedure for camping to a cell 800 is an example of camping to a cell supporting providing SIB1 on demand (i.e., not periodically broadcasting SIB1, but instead broadcasting SIB1 upon SIB1 request) upon releasing an RRC_CONNECTION.

Procedure 800 begins at operation 810, where a UE 802 in an RRC_CONNECTED state and communicating with PCell 804 (“Cell A”). At operation 820, UE 802 acquires a SIB1 request configuration of one or more cell(s) while the UE 702 is in the RRC_CONNECTED state.

In some embodiments, if an active BWP supports a common search space with the field searchSpaceOther SystemInformation, UE 802 may acquire a SIB broadcast by the Cell A wherein the acquired SIB includes a SIB1 request configuration of one or more cell(s). In embodiments such as these, the UE 702 may acquire the SIB if UE 702 does not have a valid stored version of a SIB which the Cell A supports.

Alternatively, in some embodiments, UE 802 may receive a SIB in a dedicated signaling message from Cell A, wherein the acquired SIB includes the SIB1 request configuration of one or more cell(s). In embodiments such as these, Cell A may send the SIB including the SIB1 request configuration of one or more cell(s) in dedicated a signaling message if the common search space with the field searchSpaceOtherSystemInformation is not configured in the active BWP.

Alternatively, in some embodiments, UE 802 may send an RRC system information request message including a request for a SIB which includes a SIB1 request configuration of one or more cell(s). In embodiments such as these, Cell A may send the SIB including a SIB1 request configuration of one or more cell(s) in a dedicated signaling message after receiving the request. UE 802 may send the request if an active BWP is not configured with a common search space with the field searchSpaceOtherSystemInformation and UE 802 does not have a valid stored version of a SIB which the Cell A supports and onDemandSIB-Request is configured and timer T350 is not running (and/or a request for a SIB including a SIB1 request configuration of one or more cell(s) is configured).

At operation 830, UE 802 stores the SIB1 request configuration received at operation 820.

While the UE 802 is in an RRC_CONNECTED state and communicating with PCell 804 (i.e., Cell A), UE 802 may receive an RRCRelease message at operation 840. At operation 850, UE 802 releases the RRC_CONNECTION and enters an RRC_IDLE/RRC_INACTIVE state upon receiving the RRCRelease message. Upon releasing the connection, the UE 802 may perform cell selection and select a cell 806 (“Cell B”). At operation 860, if UE 802 determines that the Cell B provides SIB1 on demand (i.e., not periodically broadcasting SIB1, but instead broadcasting SIB1 upon SIB1 request), At operation 870 UE 802 sends a SIB1 request to Cell B. For example, UE 802 may determine whether Cell B provides SIB1 on demand based on information in a MIB of Cell B, (UE 802 acquiring the MIB before acquiring SIB1).

In some embodiments, UE 802 may send the SIB1 request to Cell B if the (last) SIB1 request configuration (e.g., SIBx, a SIB which includes a SIB1 request configuration) acquired from Cell A (or alternately a Cell C other than Cell A) includes a SIB1 request configuration of Cell B.

Alternatively, in some embodiments, UE 802 may send the SIB1 request to Cell B, if the (last) SIB1 request configuration (e.g., SIBx, a SIB which include SIB1 request configuration) acquired from Cell A (or alternately Cell C other than Cell A) includes SIB1 request configuration of Cell B and the SIB1 request configuration (e.g., SIBx, a SIB which includes a SIB1 request configuration) was acquired in the current modification period.

Alternatively, in some embodiments, UE 802 may send the SIB1 request to Cell B, if the (last) SIB1 request configuration (e.g., SIBx, a SIB which includes a SIB1 request configuration) acquired from Cell A (or alternately Cell C other than Cell A) includes a SIB1 request configuration of Cell B and the SIB1 request configuration (e.g., SIBx) is valid in the current modification period.
The SIB1 request configuration (e.g., SIBx) can be valid in the current modification period, if it was acquired in the current modification period.
The SIB1 request configuration (e.g., SIBx) can be valid in the current modification period (N), if an SI change notification was received in the previous modification period (N−1) and the SIB1 acquired in the current modification period indicates that the valueTag of SIBx is same as the valueTag of the last acquired SIBx.
The SIB1 request configuration (e.g., SIBx) can be valid in the current modification period (N), if an SI change notification was not received in previous modification period (N−1).
The SIB1 request configuration (e.g., SIBx) can be valid in the current modification period (N), if the UE 802 already had/maintained the SIB1 request configuration (e.g., SIBx) and if an aSI change notification was received in previous modification period (N−1) and a SIB1 acquired in current modification period indicates that the valueTag of the SIBx is the same as the valueTag of last acquired SIBx.
The SIB1 request configuration (e.g., SIBx) can be valid in the current modification period (N), if the UE 802 already had/maintained the SIB1 request configuration (e.g., SIBx) and if an SI change notification was not received in previous modification period (N−1).

Alternatively, in some embodiments, UE 802 may send the SIB1 request to Cell B, if the (last) SIB1 request configuration (e.g., SIBx, a SIB which includes a SIB1 request configuration) acquired from Cell A (or alternately a Cell C other than Cell A) includes a SIB1 request configuration of Cell B and the timer T311 was started in same modification period in which the UE 802 has acquired the SIB1 request configuration (e.g., SIBx, a SIB which includes a SIB1 request configuration).

Alternatively, in some embodiments, UE 802 may send the SIB1 request to Cell B, if the (last) SIB1 request configuration (e.g., SIBx, a SIB which includes a SIB1 request configuration) acquired from Cell A (or alternately a Cell C other than Cell A) includes a SIB1 request configuration of Cell B and the current time belongs to same modification period in which the UE 802 has acquired the SIB1 request configuration (e.g., SIBx, a SIB which includes a SIB1 request configuration).

Alternatively, in some embodiments, UE 802 may send the SIB1 request to Cell B, if the (last) SIB1 request configuration (e.g., SIBx, a SIB which includes a SIB1 request configuration) acquired from Cell A (or alternately a Cell C other than Cell A) includes a SIB1 request configuration of Cell B and the time for initiating SIB1 request/transmit SIB1 request belongs to same modification period in which the UE has acquired the SIB1 request configuration (e.g., SIBx, a SIB which includes a SIB1 request configuration).

Alternatively, in some embodiments, UE 802 may send the SIB1 request to Cell B, if the (last) SIB1 request configuration (e.g., SIBx, a SIB which includes a SIB1 request configuration) acquired from Cell A (or alternately a Cell C other than Cell A) includes a SIB1 request configuration of Cell B and timer T is running wherein the timer T is (re-)started when the SIB1 request configuration of Cell B was received. The value of the timer T may be received in SIB including SIB1 request configuration of Cell B or in any other SIB or RRC message. Timer T can be separately configured per SIB1 request configuration included in the SIB or timer T can be commonly configured for all SIB1 request configurations included in the SIB.

Alternatively, in some embodiments, UE 802 may send the SIB1 request to Cell B, if the (last) SIB1 request configuration (e.g., SIBx, a SIB which includes a SIB1 request configuration) acquired from Cell A (or alternately a Cell C other than Cell A) includes a SIB1 request configuration of Cell B and current real time (e.g., UTC time) is earlier than the UTC time until which the acquired SIB1 request configuration of Cell B is valid. The real time (e.g., UTC) time until which the acquired SIB1 request configuration of Cell B is valid may be received in a SIB including a SIB1 request configuration of Cell B. This validity time can be separately configured per SIB1 request configuration included in the SIB or can be commonly configured for all SIB1 request configurations included in the SIB.

Alternatively, in some embodiments, UE 802 may send the SIB1 request to Cell B, if the (last) SIB1 request configuration (e.g., SIBx, a SIB which includes a SIB1 request configuration) acquired from Cell A (or alternately a Cell C other than Cell A) includes a SIB1 request configuration of Cell B and the current real time (e.g., UTC) time is earlier than the UTC time until which the acquired SIB1 request configuration of Cell B is valid. The SIB1 request configuration of Cell B is valid from T1 to T1+T2. The real time (e.g., UTC) time T1 from which the acquired SIB1 request configuration of Cell B becomes valid may be received in a SIB including a SIB1 request configuration of Cell B. This time T1 can be separately configured per SIB1 request configuration included in the SIB or can be commonly configured for all SIB1 request configurations included in the SIB. The timer T2 until which the acquired SIB1 request configuration of Cell B is valid may be received in SIB including SIB1 request configuration of Cell B or in another SIB1 or RRC message. This time T2 can be separately configured per SIB1 request configuration included in the SIB or can be commonly configured for all SIB1 request configurations included in the SIB.

At operation 870, UE 802 acquires the SIB1 of Cell B in response to the SIB1 request at operation 870. At operation 890, UE 802 camps in Cell B.

Although FIG. 8 illustrates one example procedure for camping to a cell 800, various changes may be made to FIG. 8. For example, while shown as a series of operations, various operations in FIG. 8 could overlap, occur in parallel, occur in a different order, occur any number of times, be omitted, or replaced by other operations.

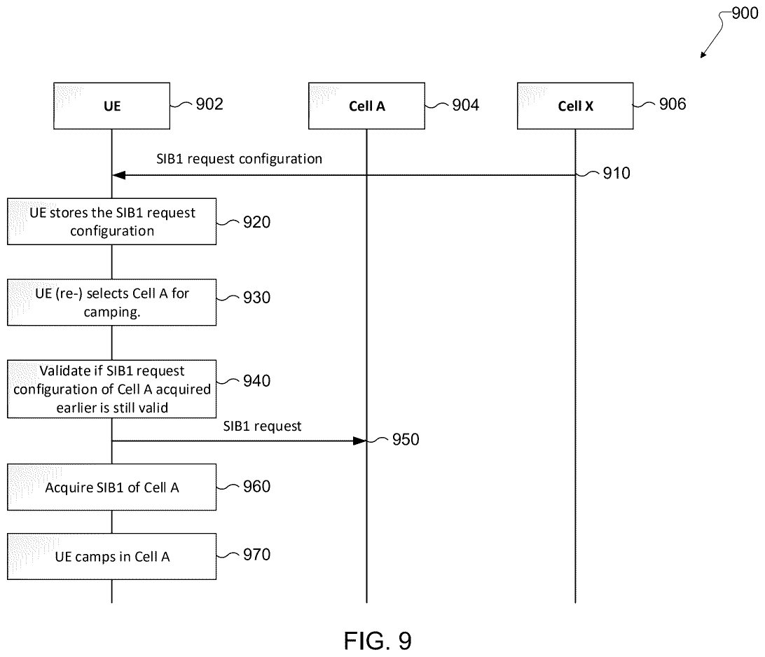

FIG. 9 illustrates an example procedure for a SIB1 request 900 according to embodiments of the present disclosure. An embodiment of the procedure illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of a procedure for a SIB1 request could be used without departing from the scope of this disclosure.

In the example of FIG. 9, the procedure for a SIB1 request 900 is an example of a SIB1 request to a cell providing SIB1 on demand (i.e., not periodically broadcasting SIB1, but instead broadcasting SIB1 upon SIB1 request) based on a SIB1 request configuration acquired earlier from same cell or a different cell.

Procedure 900 begins at operation 910, where a UE 902 acquires a SIB (e.g., “SIB A”) including a SIB1 request configuration of one or more cells from a Cell 906 (“Cell X”). At operation 920, UE 902 stores the acquired SIB1 request configuration of one or more cells.

In some embodiments, UE 902 starts a timer T. The value of the timer T may be received in SIB A including SIB1 request configurations or in any other SIB. Timer T can be separately configured per SIB1 request configuration included in the SIB A and in this case timer T is started for each SIB1 request configuration. Alternately, timer T can be commonly configured for all SIB1 request configurations included in the SIB A and in this case one timer T may be started. In embodiments such as these, the acquired SIB1 request configuration is valid while timer T (or timer T corresponding to the SIB1 request configuration) is running. The acquired SIB1 request configuration is discarded upon expiry of timer T (or timer T corresponding to the SIB1 request configuration).

Alternatively, in some embodiments, the SIB A may include a real time (e.g., UTC time) (Tᵣₑₐₗ) until which the acquired SIB1 request configuration is valid. This time can be separately configured per SIB1 request configuration included in the SIB A or can be commonly configured for all SIB1 request configurations included in the SIB A. In embodiments such as these, the acquired SIB1 request configuration is valid until Tᵣₑₐₗ. The acquired SIB1 request configuration is discarded at/after Tᵣₑₐₗ.

Alternatively, in some embodiments, the acquired SIB1 request configuration is valid from a time T1 to T1+T2. The real time (e.g., UTC time) T1 from which the acquired SIB1 request configuration becomes valid is received in SIB A. This time T1 can be separately configured per SIB1 request configuration included in the SIB A or can be commonly configured for all SIB1 request configurations included in the SIB A. The timer T2 until which the acquired SIB1 request configuration is valid may be received in SIB A or in another SIB1 or RRC message. This time T2 can be separately configured per SIB1 request configuration included in the SIB A or can be commonly configured for all SIB1 request configurations included in the SIB A.

Later, at operation 930, UE 902 selects or reselects a Cell 904 (“Cell A”) for camping. At operation 940, if UE 902 determines the Cell A provides SIB1 on demand (i.e., not periodically broadcasting SIB1, broadcasting SIB1 upon SIB1 request), at operation 950 UE 902 sends a SIB1 request to Cell A. For example, UE 902 may determine whether Cell A provides SIB1 on demand based on information in a MIB of Cell A, (UE 902 acquiring the MIB before acquiring SIB1). Cell A can be the same as a Cell A (e.g., if UE 902 goes out of coverage of Cell B and then selects Cell B later for camping or UE 902 first moves from Cell B to a Cell C and later moves from Cell C to Cell B). Cell A can also be different from Cell B.

In some embodiments, UE 902 may send the SIB1 request to Cell A if the UE 902 has a stored SIB1 request configuration of Cell A.

In some embodiments, UE 902 may send the SIB1 request to Cell A if the UE 902 has stored SIB1 request configuration of Cell A and the SIB1 request configuration was acquired in the current modification period.

Alternatively, in some embodiments, UE 902 may send the SIB1 request to Cell A, if the (last) SIB1 request configuration (e.g., SIBx, a SIB which includes a SIB1 request configuration) acquired from Cell X (or alternately Cell C other than Cell X) includes a SIB1 request configuration of Cell A and the SIB1 request configuration (e.g., SIBx) is valid in the current modification period.
The SIB1 request configuration (e.g., SIBx) can be valid in the current modification period, if it was acquired in the current modification period.
The SIB1 request configuration (e.g., SIBx) can be valid in the current modification period (N), if an SI change notification was received in the previous modification period (N−1) and the SIB1 acquired in the current modification period indicates that the valueTag of SIBx is same as the valueTag of the last acquired SIBx.
The SIB1 request configuration (e.g., SIBx) can be valid in the current modification period (N), if an SI change notification was not received in previous modification period (N−1).
The SIB1 request configuration (e.g., SIBx) can be valid in the current modification period (N), if the UE 802 already had/maintained the SIB1 request configuration (e.g., SIBx) and if an aSI change notification was received in previous modification period (N−1) and a SIB1 acquired in current modification period indicates that the valueTag of the SIBx is the same as the valueTag of last acquired SIBx.
The SIB1 request configuration (e.g., SIBx) can be valid in the current modification period (N), if the UE 802 already had/maintained the SIB1 request configuration (e.g., SIBx) and if an SI change notification was not received in previous modification period (N−1).

Alternatively, in some embodiments, UE 902 may send the SIB1 request to Cell A, if the UE 902 has stored a SIB1 request configuration of Cell A and the Cell A was selected in same modification period in which the UE 902 has acquired the SIB1 request configuration.

Alternatively, in some embodiments, UE 902 may send the SIB1 request to Cell A, if the UE 902 has stored a SIB1 request configuration of Cell A and the current time belongs to the same modification period in which the UE 902 has acquired the SIB1 request configuration.

Alternatively, in some embodiments, UE 902 may send the SIB1 request to Cell A, if the UE 902 has stored a SIB1 request configuration of Cell A and the time for initiating SIB1 request/transmit SIB1 request belongs to same modification period in which the UE 902 has acquired the SIB1 request configuration.

Alternatively, in some embodiments, UE 902 may send the SIB1 request to Cell A, if the UE 902 has stored a SIB1 request configuration of Cell A and a timer T is running, wherein the timer T is (re-)started when the SIB1 request configuration of Cell A was received. The value of the timer T may be received in a SIB including the SIB1 request configuration of Cell A or in any other SIB or RRC message. Timer T can be separately configured per SIB1 request configuration included in the SIB or timer T can be commonly configured for all SIB1 request configurations included in the SIB.

Alternatively, in some embodiments, UE 902 may send the SIB1 request to Cell A if the UE 902 has stored a SIB1 request configuration of Cell A and current real time (e.g., UTC time) is earlier than the UTC time until which the acquired SIB1 request configuration of Cell A is valid. The real time (e.g., UTC time) until which the acquired SIB1 request configuration of Cell A is valid may be received in SIB including SIB1 request configuration of Cell A. This validity time can be separately configured per SIB1 request configuration included in the SIB or can be commonly configured for all SIB1 request configurations included in the SIB.

Alternatively, in some embodiments, UE 902 may send the SIB1 request to Cell A if the UE 902 has stored a SIB1 request configuration of Cell A and a current real time (e.g., UTC time) is earlier than the UTC time until which the acquired SIB1 request configuration of Cell A is valid. The SIB1 request configuration of Cell A is valid from a time T1 to T1+T2. The real time (e.g., UTC time) T1 from which the acquired SIB1 request configuration of Cell A becomes valid may be received in a SIB including a SIB1 request configuration of Cell A. This time T1 can be separately configured per SIB1 request configuration included in the SIB or can be commonly configured for all SIB1 request configurations included in the SIB. The timer T2 until which the acquired SIB1 request configuration of Cell A is valid may be received in the SIB including the SIB1 request configuration of Cell A or in another SIB1 or RRC message. This time T2 can be separately configured per SIB1 request configuration included in the SIB or can be commonly configured for all SIB1 request configurations included in the SIB.

At operation 960, UE 902 acquires the SIB1 of Cell A in response to the SIB1 request at operation 950. At operation 970, UE 902 camps in Cell A.

Although FIG. 9 illustrates one example procedure for a SIB1 request 900, various changes may be made to FIG. 9. For example, while shown as a series of operations, various operations in FIG. 9 could overlap, occur in parallel, occur in a different order, occur any number of times, be omitted, or replaced by other operations.

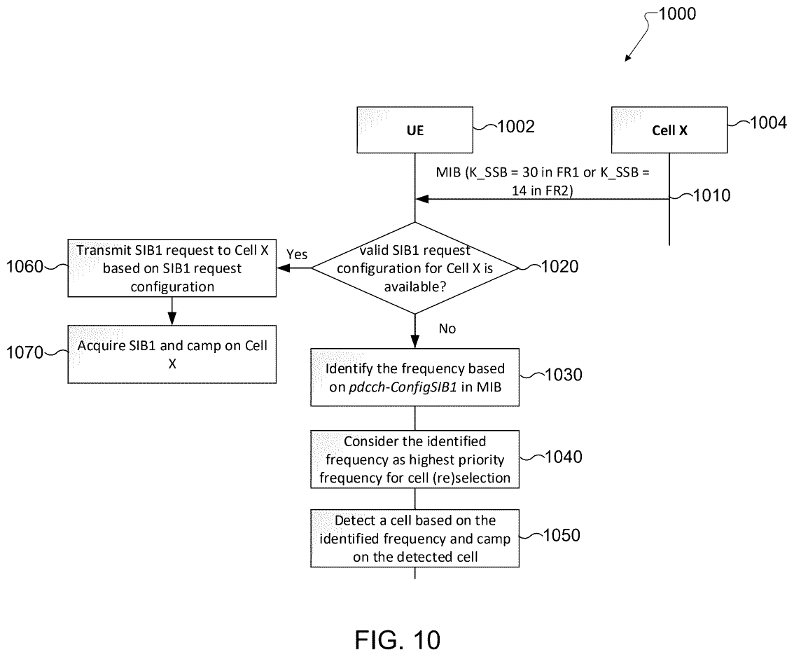

FIG. 10 illustrates an example procedure for camping in a cell 1000 according to embodiments of the present disclosure. An embodiment of the procedure illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of a procedure for camping in a cell could be used without departing from the scope of this disclosure.

In the example of FIG. 10, the procedure 1000 begins at operation 1010. At operation 1010, a UE 1002 acquires a MIB of a Cell 1004 (“Cell X”).

In some embodiments, if the UE 1002 acquires this MIB/SSB on an FR1 carrier frequency and the SSB/MIB includes/indicates K_SSB=30; or if the UE acquires this SSB/MIB on an FR2 carrier frequency and SSB/MIB includes/indicates K_SSB=14:
At operation 1020, UE 1002 determines/checks if the UE 1002 has a valid SIB1 request configuration for Cell X.
If UE 902 does not have a valid/stored SIB1 request configuration for Cell X:
   UE 902 may bar the Cell X
   At operation 1030, UE 902 identifies the frequency (e.g., frequency where UE may find SS/PBCH block with SIB1) based on pdcch-ConfigSIB1 in the MIB. At operation 1040, UE 902 considers the identified frequency as the highest priority frequency for cell (re) selection. At operation 1050, UE 902 detects a cell based on the identified frequency and camps on the detected cell.
If UE 902 has a valid/stored (validity may be determined as explained herein) SIB1 request configuration for Cell X:
   UE 902 may ignore the pdcch-ConfigSIB1 in the acquired MIB.
   UE initiates SIB1 request procedure towards Cell X. At operation 1060, UE 902 transmits a SIB1 request (e.g., a RACH preamble dedicated for a SIB1 request or RRC message) to Cell X based on the SIB1 request configuration. At operation 1070, UE 902 then acquires the SIB1 (e.g., after receiving an ack/RAR for the SIB1 request). UE camps on Cell X after the SIB1 acquisition.

Alternatively, in some embodiments, if the UE 902 acquires this SSB/MIB on an FR1 carrier frequency and SSB/MIB includes/indicates K_SSB=30; or if the UE 902 acquires this SSB/MIB on an FR2 carrier frequency and SSB/MIB includes/indicates K_SSB=14:
UE 902 may bar the Cell X
UE identifies the frequency (e.g., frequency where UE 902 may find SS/PBCH block with SIB1) based on pdcch-ConfigSIB1 in the MIB. UE 902 considers the identified frequency as the highest priority frequency for cell (re) selection. UE 902 detects a cell based on the identified frequency and camp on the detected cell.

Although FIG. 10 illustrates one example procedure for camping in a cell 1000, various changes may be made to FIG. 10. For example, while shown as a series of operations, various operations in FIG. 10 could overlap, occur in parallel, occur in a different order, occur any number of times, be omitted, or replaced by other operations.

In some embodiments, if a random access procedure was initiated for a SIB1 request, a MAC entity in the UE sets the RA_TYPE to 4-stepRA upon initiation of the random access procedure.

In some embodiments, if a random access procedure was initiated for a SIB1 request, if at least one of the SSBs (amongst the SSBs transmitted in the cell) with SS-RSRP above rsrp-ThresholdSSB is available, the UE selects an SSB with SS-RSRP above rsrp-ThresholdSSB. Otherwise, the UE selects any SSB. The UE selects a random access preamble corresponding to the selected SSB, from random access preamble(s) determined according to ra-PreambleStartIndex. The UE sets the PREAMBLE INDEX to the selected Random Access Preamble.

In some embodiments, if a random access procedure was initiated for a SIB1 request, and if ra-AssociationPeriodIndex and si-RequestPeriod are configured, the UE determines the next available PRACH occasion from the PRACH occasions corresponding to the selected SSB in the association period given by ra-AssociationPeriodIndex in the si-RequestPeriod permitted by the restrictions given by the ra-ssb-OccasionMaskIndex if configured (the MAC entity shall select a PRACH occasion randomly with equal probability amongst the consecutive PRACH occasions corresponding to the selected SSB).

In some embodiments, if an LBT failure indication is received from lower layers for this Random Access Preamble transmission:
if Ibt-FailureRecoveryConfig is configured, the UE performs the random access resource selection procedure. Otherwise:
   the UE increments the PREAMBLE_TRANSMISSION_COUNTER by 1. If PREAMBLE_TRANSMISSION_COUNTER=preambleTransMax+1:
      if the random access Preamble is transmitted on the SpCell, the UE indicates a random access problem to upper layers;
      if this random access procedure was triggered for a SIB1 request, the UE considers the random access procedure unsuccessfully completed.
   if the random access procedure is not completed, the UE performs the random access resource selection procedure.

In some embodiments, upon reception of a RAR, if the RAR contains a MAC subPDU with a random access preamble identifier corresponding to the transmitted PREAMBLE INDEX, the UE considers this RAR reception successful. In embodiments such as these, if the RAR reception is considered successful if the RAR includes a MAC subPDU with RAPID only, the UE considers this random access procedure successfully completed. If this random access procedure was triggered for an SI request, the UE indicates the reception of an acknowledgement for the SI request to upper layers. Otherwise, if this random access procedure was triggered for a SIB1 request, the UE indicates the reception of an acknowledgement for the SIB1 request to upper layers.

In some embodiments, if ra-ResponseWindow configured in RACH-ConfigCommon expires, and if a RAR containing the random access preamble identifiers that matches the transmitted PREAMBLE INDEX has not been received, the UE:
considers the Random Access Response reception not successful;
increments PREAMBLE_TRANSMISSION_COUNTER by 1;
if PREAMBLE_TRANSMISSION_COUNTER=preambleTransMax+1:
   if the Random Access Preamble is transmitted on the SpCell, the UE
      indicates a random access problem to upper layers;
      if this random access procedure was triggered for SIB1 request, the UE considers the random access procedure unsuccessfully completed.

In some embodiments, if a MAC subPDU with backoff indicator is received in a RAR during a random access procedure for a SIB1 request, the UE ignores the back off indicator (i.e., the UE does not apply backoff before the retransmission of the random access preamble).

In some embodiments, upon initiation of a random access procedure, after selection of the carrier for performing Random Access procedure, if the UE is an (e) RedCap UE in an RRC_IDLE or RRC_INACTIVE mode, the MAC entity shall:
if initialUplinkBWP-RedCap is configured for the selected carrier, perform the random access procedure by using the BWP configured by initialUplinkBWP-RedCap. Otherwise, perform the Random Access procedure by using the BWP configured by initialUplinkBWP,
if initialDownlinkBWP-RedCap is configured and if a random access procedure is not triggered for the SIB1 request:
   if the Random Access procedure was initiated for SI request and the random access resources for the SI request have been explicitly provided by RRC, and if the selected carrier is thee SUL carrier, monitor the PDCCH on the BWP configured by initialDownlinkBWP. Otherwise, monitor the PDCCH on the BWP configured by initialDownlinkBWP-RedCap.
Otherwise, monitor the PDCCH on the BWP configured by initialDownlinkBWP.

Alternatively, in some embodiments, upon initiation of a random access procedure, after selection of the carrier for performing the random access procedure, if the UE is an (e) RedCap UE in an RRC_IDLE or RRC_INACTIVE mode and, the MAC entity shall:
if initialUplinkBWP-RedCap is configured for the selected carrier, perform the random access procedure by using the BWP configured by initialUplinkBWP-RedCap. Otherwise, perform the random access procedure by using the BWP configured by initialUplinkBWP.
If initialDownlinkBWP-RedCap is configured, if (ii) the random access procedure was initiated for SI request and the Random Access Resources for SI request have been explicitly provided by RRC, and if the selected carrier is the SUL carrier or (ii) if the random access procedure was initiated for the SIB1 request, and if the selected carrier is the SUL carrier, monitor the PDCCH on the BWP configured by initialDownlinkBWP. Otherwise, monitor the PDCCH on the BWP configured by initialDownlinkBWP-RedCap.
Otherwise, monitor the PDCCH on the BWP configured by initialDownlinkBWP.

IN some embodiments, if the RAPID in the MAC subheader of a MAC subPDU corresponds to one of the random access preambles configured for a SIB1 request, the MAC RAR is not included in the MAC subPDU.

As noted above, various embodiments of the present disclosure provide mechanisms for a UE to determine an LO to monitor for an LP WUS.

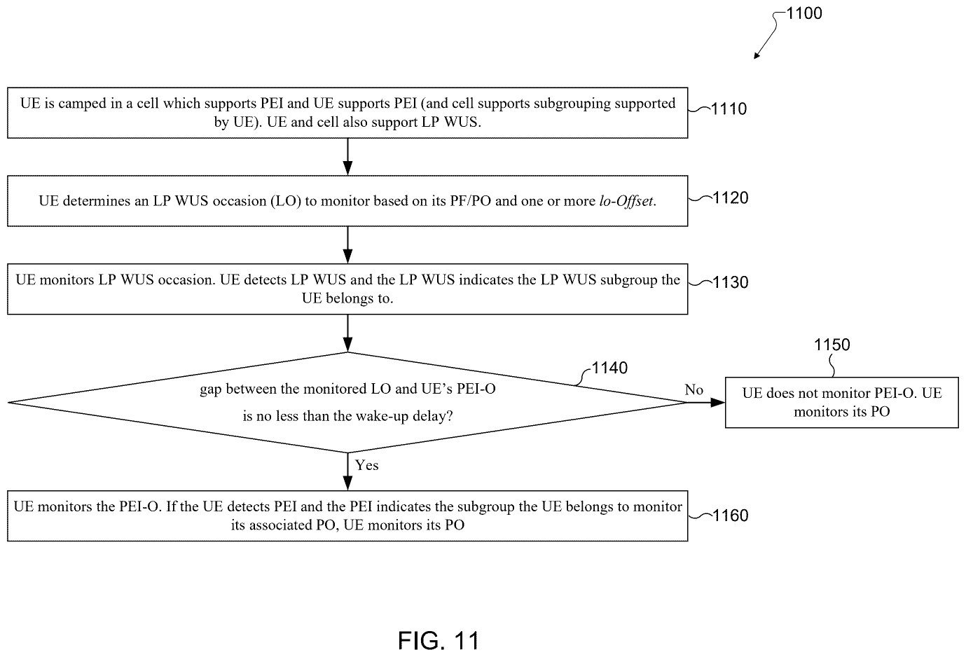

FIG. 11 illustrates an example procedure for PO monitoring 1100 according to embodiments of the present disclosure. An embodiment of the procedure illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of a procedure for PO monitoring could be used without departing from the scope of this disclosure.

In the example of FIG. 11, procedure 1100 begins at operation 1110. At operation 1110, a UE (such as UE 116) is camped in a cell which supports PEI and the UE supports PEI (and the cell supports subgrouping supported by the UE). The UE and cell also support LPWUS (which can also be referred to as a WUS).

At operation 1120, the UE determines an LP WUS occasion (LO) to monitor based on the UE's PF/PO and one or more configured offsets (lo-Offset is the offset between PF/PO and LO).

In some embodiments, a gNB configures a single offset (lo-Offset) between the LO and PF/PO. The UE monitors the LO if the gap between the LO and the UE's PF/PO is no less than the wake-up delay (i.e., the UE monitors the LO if this gap between the LO and the UE's PF/PO is greater than or equal to the wake-up delay). Otherwise, the UE does not monitor LP WUS.

In some embodiments, a gNB configures two offset values between LO and PF/PO. If multiple offset values are configured and if the gap between the LO associated with the largest offset value and the corresponding PF/PO is no less than the wake-up delay, the UE monitors the LO associated with the smallest offset value that has a gap between the LO and the PFPO no less than the wake-up delay. Otherwise, UE does not monitor LP WUS.

At operation 1130, in the monitored LPWUS occasion, the UE detects an LP WUS and the LP WUS indicates the LPWUS subgroup the UE belongs to.

At operation 1140, the UE if the gap between the monitored LO and UE's PEI-O is no less than the wake-up delay, the procedure proceeds to operation 1150. Otherwise, the procedure proceeds to operation 1160

At operation 1150, the UE monitors the PEI-O. If the UE detects a PEI in the monitored PEI-O and the PEI indicates the subgroup the UE belongs to monitor its associated PO, the UE monitors its PO.

At operation 1160, the UE does not monitor PEI-O, and the UE monitors its PO.

Although FIG. 11 illustrates one example procedure for PO monitoring 1100, various changes may be made to FIG. 11. For example, while shown as a series of operations, various operations in FIG. 11 could overlap, occur in parallel, occur in a different order, occur any number of times, be omitted, or replaced by other operations.

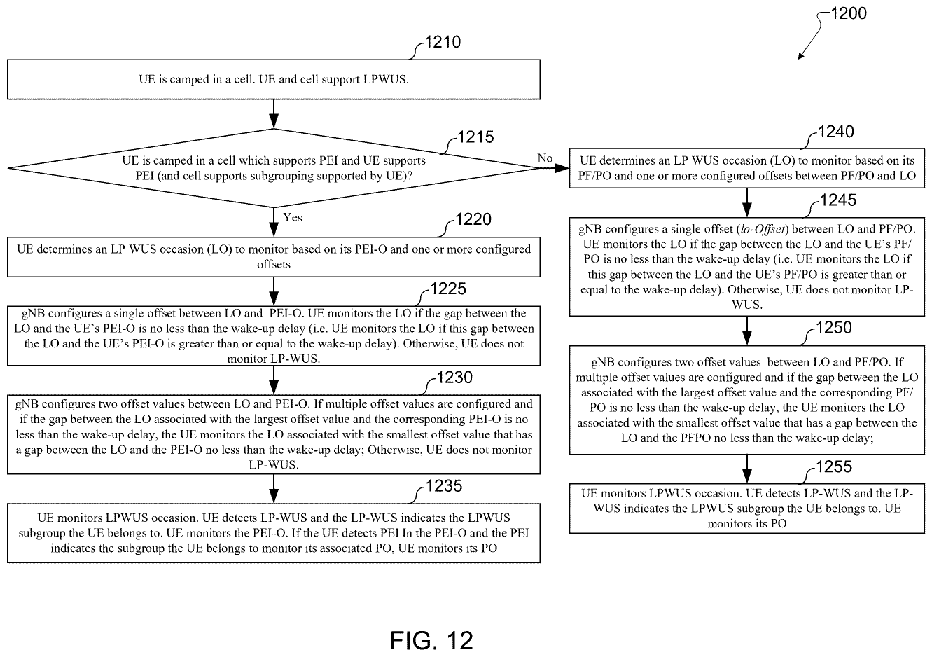

FIG. 12 illustrates an example procedure for LP WUS monitoring 1200 according to embodiments of the present disclosure. An embodiment of the procedure illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of a procedure for LP WUS monitoring could be used without departing from the scope of this disclosure.

In the example of FIG. 12, procedure 1200 begins at operation 1210. At operation 1210, a UE (such as UE 116) is camped in a cell, and UE and the cell support LPWUS.

At operation 1215, if the UE is camped in a cell which supports PEI and the UE supports PEI (and the cell supports subgrouping supported by the UE), the procedure proceeds to operation 1220. Otherwise, the procedure proceeds to operation 1240.

At operation 1220, the UE determines an LP WUS occasion (LO) to monitor based on its PEI-O and one or more lo-Offset (lo-Offset is the same as the configured offset between PF/PO and LO or alternately, lo-Offset is the separately configured offset between PEI-O and LO).

At operation 1225, a gNB configures a single offset (lo-Offset) between the LO and PF/PO/PEI-O (or PEI-O). the UE monitors the LO if this gap (offset) between the LO and the UE's PEI-O is no less than the wake-up delay (i.e., the UE monitors the LO if this gap between the LO and the UE's PEI-O is greater than or equal to the wake-up delay). Otherwise, the UE does not monitor for an LP WUS.

At operation 1230, the gNB configures two offset values between the LO and PF/PO/PEI-O (or PEI-O). If multiple offset values are configured and if the gap between the LO associated with the largest offset value and the corresponding PEI-O is no less than the wake-up delay, the UE monitors the LO associated with the smallest offset value that has a gap between the LO and the PEI-O no less than the wake-up delay. Otherwise, UE does not monitor for an LP WUS.

The wakeup delay (reported by the UE to the network) can be common for wakeup for PO monitoring or PEI-O monitoring. Wakeup delay (reported by UE to network) can be separate for wakeup for PO monitoring and PEI-O monitoring.

At operation 1235, in the monitored LPWUS occasion, if the UE detects an LP WUS and the LP WUS indicates the LPWUS subgroup the UE belongs to, the UE monitors the PEI-O. If the UE detects a PEI in the monitored PEI-O and the PEI indicates the subgroup the UE belongs to monitor its associated PO, the UE monitors its PO.

At operation 1240, the UE determines an LP WUS occasion (LO) to monitor based on its PF/PO and one or more lo-Offset (lo-Offset is the offset between PF/PO and LO).

At operation 1245, the gNB configures a single offset (lo-Offset) between the LO and PF/PO. The UE monitors the LO if this gap between the LO and the UE's PF/PO is no less than the wake-up delay (i.e., the UE monitors the LO if this gap between the LO and the UE's PF/PO is greater than or equal to the wake-up delay). Otherwise, the UE does not monitor for an LP WUS.

At operation 1250, the gNB configures two offset values between the LO and PF/PO. If multiple offset values are configured and if the gap between the LO associated with the largest offset value and the corresponding PF/PO is no less than the wake-up delay, the UE monitors the LO associated with the smallest offset value that has a gap between the LO and the PFPO no less than the wake-up delay. Otherwise, the UE does not monitor for an LP WUS.

At operation 1255, in the monitored LPWUS occasion, if the UE detects an LP WUS and the LP WUS indicates the LPWUS subgroup the UE belongs to, the UE monitors its PO.

Although FIG. 12 illustrates one example procedure for LP WUS monitoring 1200, various changes may be made to FIG. 12. For example, while shown as a series of operations, various operations in FIG. 12 could overlap, occur in parallel, occur in a different order, occur any number of times, be omitted, or replaced by other operations.

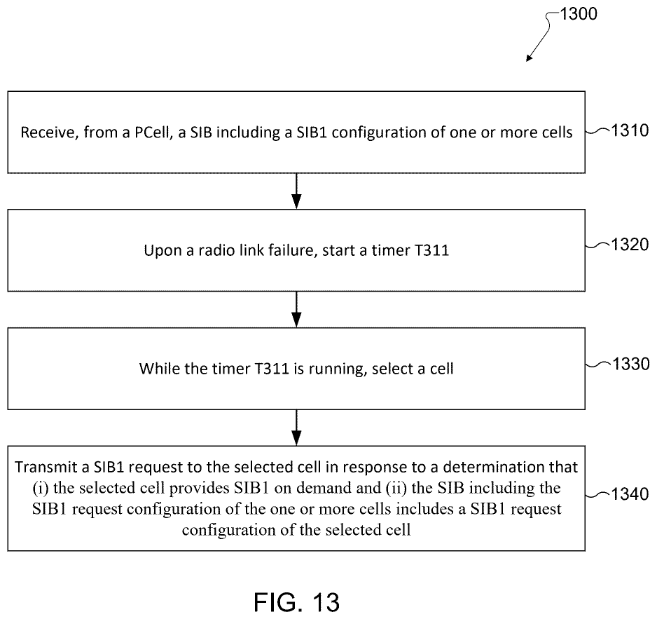

FIG. 13 illustrates an example method for validating a SIB1 request configuration 1300 according to embodiments of the present disclosure. An embodiment of the method illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments of a method for validating a SIB1 request configuration could be used without departing from the scope of this disclosure.

In the example of FIG. 13, the method begins at step 1310. At step 1310, a UE (such as UE 116) receives, form a PCell, a SIB including a SIB1 configuration of one or more cells.

At step 1320, upon a radio link failure, the UE starts a timer T311. At step 1330, while the timer T311 is running, the UE selects a cell. At step 1340, the UE transmits a SIB1 request to the selected cell in response to a determination that (i) the selected cell provides SIB1 on demand and (ii) the SIB including the SIB1 request configuration of the one or more cells includes a SIB1 request configuration of the selected cell.

In some embodiments, the UE may acquire the SIB including the SIB1 request configuration of the one or more cells in a broadcast by the PCell in response to a determination that an active bandwidth part (BWP) supports a common search space with a field searchSpaceOtherSystemInformation.

IN some embodiments, the UE may transmit a request for the SIB including the SIB1 request configuration of the one or more cells in response to a determination that a common search space with a field searchSpaceOtherSystemInformation is not configured in an active bandwidth part (BWP).

In some embodiments, the UE may receive the SIB including the SIB1 request configuration of the one or more cells in a dedicated radio resource control (RRC) message from the PCell.

In some embodiments, the UE may receive the SIB including the SIB1 request configuration of the one or more cells in a dedicated radio resource control (RRC) message from the PCell.

In some embodiments, the UE may determine whether the selected cell provides a SIB1 on demand based on a master information block (MIB) of the selected cell.

In some embodiments, the UE may transmit the SIB1 request to the selected cell in response to a further determination that (iii) the SIB including the SIB1 request configuration of the one or more cells is valid in a current modification period.

In some embodiments, the UE may start or restart a timer T when the SIB including the SIB1 request configuration of the one or more cells is received. In embodiments such as these, the UE may transmit the SIB1 request to the selected cell in response to a further determination by the processor that (iii) the timer T is running.

In some embodiments, the UE may transmit the SIB1 request to the selected cell in response to a further determination that (iii) a current coordinated universal time (UTC) is earlier than a UTC time in which the SIB1 request configuration of the selected cell in the SIB including the SIB1 request configuration of the one or more cells is no longer valid.

Although FIG. 13 illustrates one example method for validating a SIB1 request configuration 1300, various changes may be made to FIG. 13. For example, while shown as a series of steps, various steps in FIG. 13 could overlap, occur in parallel, occur in a different order, occur any number of times, be omitted, or replaced by other steps.

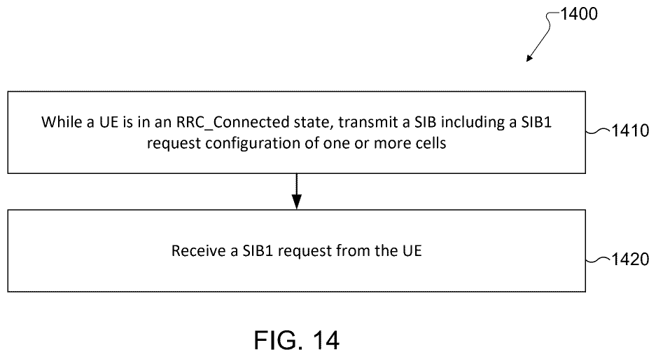

FIG. 14 illustrates an example method for validating a SIB1 request configuration 1400 according to embodiments of the present disclosure. An embodiment of the method illustrated in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments of a method for validating a SIB1 request configuration could be used without departing from the scope of this disclosure.

In the example of FIG. 14, the method begins at step 1410. At step 1410, a BS (such as gNB 116) Transmits a SIB including a SIB1 request configuration of one or more cells while a UE (such as UE 116) is in an RRC_Connected state. A cell of the BS is a PCell of the UE. The BS provides SIB1 on demand, and the SIB1 request configuration of the one or more cells includes a SIB1 request configuration of a cell of the BS.

At operation 1420, the BS receives a SIB1 request from the UE.

In some embodiments, an active bandwidth part (BWP) of the PCell may support a common search space with a field searchSpaceOtherSystemInformation, and the BS may be configured to transmit the SIB including the SIB1 request configuration of the one or more cells in a broadcast by the BS.

In some embodiments, a common search space with a field searchSpaceOtherSystemInformation may not be configured in an active bandwidth part (BWP) of the BS, and the BS may be configured to receive a request for the SIB including the SIB1 request configuration of the one or more cells.

In some embodiments, the BS may be configured to transmit the SIB including the SIB1 request configuration of the one or more cells in a dedicated radio resource control (RRC) message from the PCell.

Although FIG. 14 illustrates one example method for validating a SIB1 request configuration 1400, various changes may be made to FIG. 14. For example, while shown as a series of steps, various steps in FIG. 14 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

1. A user equipment (UE) comprising:
a transceiver configured to, while the UE is in an RRC_CONNCECTED state, receive, from a primary cell (PCell), a system information block (SIB) including a SIB1 request configuration of one or more cells; and
a processor operably coupled to the transceiver, the processor configured to:
upon a radio link failure, start a timer T311; and
while the timer T311 is running, select a cell,
wherein the transceiver is further configured to transmit a SIB1 request to the selected cell in response to a determination by the processor that (i) the selected cell provides SIB1 on demand and (ii) the SIB including the SIB1 request configuration of the one or more cells includes a SIB1 request configuration of the selected cell.

2. The UE of claim 1, wherein the processor is further configured to cause the UE to acquire the SIB including the SIB1 request configuration of the one or more cells in a broadcast by the PCell in response to a determination that an active bandwidth part (BWP) supports a common search space with a field searchSpaceOtherSystemInformation.

3. The UE of claim 1, wherein the transceiver is further configured to transmit a request for the SIB including the SIB1 request configuration of the one or more cells in response to a determination by the processor that a common search space with a field searchSpaceOther SystemInformation is not configured in an active bandwidth part (BWP).

4. The UE of claim 1, wherein the transceiver is further configured to receive the SIB including the SIB1 request configuration of the one or more cells in a dedicated radio resource control (RRC) message from the PCell.

5. The UE of claim 1, wherein the processor is further configured to determine whether the selected cell provides a SIB1 on demand based on a master information block (MIB) of the selected cell.

6. The UE of claim 1, wherein the transceiver is further configured to transmit the SIB1 request to the selected cell in response to a further determination by the processor that (iii) the SIB including the SIB1 request configuration of the one or more cells is valid in a current modification period.

7. The UE of claim 1, wherein:
the processor is further configured to start or restart a timer T when the SIB including the SIB1 request configuration of the one or more cells is received; and
the transceiver is further configured to transmit the SIB1 request to the selected cell in response to a further determination by the processor that (iii) the timer T is running.

8. The UE of claim 1, wherein the transceiver is further configured to transmit the SIB1 request to the selected cell in response to a further determination by the processor that (iii) a current coordinated universal time (UTC) is earlier than a UTC time in which the SIB1 request configuration of the selected cell in the SIB including the SIB1 request configuration of the one or more cells is no longer valid.

9. A base station (BS) comprising:
a processor; and
a transceiver operably coupled to the processor, the transceiver configured to:
while a user equipment (UE) is in an RRC_CONNCECTED state, transmit, a system information block (SIB) including a SIB1 request configuration of one or more cells; and
receive a SIB1 request from the UE,
wherein a cell of the BS is a PCell of the UE; and
wherein the BS provides SIB1 on demand, and the SIB1 request configuration of the one or more cells includes a SIB1 request configuration of a cell of the BS.

10. The BS of claim 9, wherein:
an active bandwidth part (BWP) of the PCell supports a common search space with a field searchSpaceOther SystemInformation; and
the transceiver is further configured to transmit the SIB including the SIB1 request configuration of the one or more cells in a broadcast by the BS.

11. The BS of claim 9, wherein:
a common search space with a field searchSpaceOtherSystemInformation is not configured in an active bandwidth part (BWP) of the BS; and
the transceiver is further configured to receive a request for the SIB including the SIB1 request configuration of the one or more cells.

12. The BS of claim 9, wherein:
the transceiver is further configured to transmit the SIB including the SIB1 request configuration of the one or more cells in a dedicated radio resource control (RRC) message from the PCell.

13. A method of operating a user equipment (UE), the method comprising:
while the UE is in an RRC_CONNCECTED state, receiving, from a primary cell (PCell), a system information block (SIB) including a SIB1 request configuration of one or more cells;
upon a radio link failure, starting a timer T311;
while the timer T311 is running, selecting a cell; and
transmitting a SIB1 request to the selected cell in response to a determination that (i) the selected cell provides SIB1 on demand and (ii) the SIB including the SIB1 request configuration of the one or more cells includes a SIB1 request configuration of the selected cell.

14. The method of claim 13, further comprising acquiring the SIB including the SIB1 request configuration of the one or more cells in a broadcast by the PCell in response to a determination that an active bandwidth part (BWP) supports a common search space with a field searchSpaceOtherSystemInformation.

15. The method of claim 13, further comprising transmitting a request for the SIB including the SIB1 request configuration of the one or more cells in response to a determination that a common search space with a field searchSpaceOtherSystemInformation is not configured in an active bandwidth part (BWP).

16. The method of claim 13, further comprising receiving the SIB including the SIB1 request configuration of the one or more cells in a dedicated radio resource control (RRC) message from the PCell.

17. The method of claim 13, further comprising determining whether the selected cell provides a SIB1 on demand based on a master information block (MIB) of the selected cell.

18. The method of claim 13, further comprising transmitting the SIB1 request to the selected cell in response to a further determination that (iii) the SIB including the SIB1 request configuration of the one or more cells is valid in a current modification period.

19. The method of claim 13, further comprising:
starting or restarting a timer T when the SIB including the SIB1 request configuration of the one or more cells is received; and
transmitting the SIB1 request to the selected cell in response to a further determination that (iii) the timer T is running.

20. The method of claim 13, further comprising transmitting the SIB1 request to the selected cell in response to a further determination that (iii) a current coordinated universal time (UTC) is earlier than a UTC time in which the SIB1 request configuration of the selected cell in the SIB including the SIB1 request configuration of the one or more cells is no longer valid.
